(19) United States
(12) Patent Application Publication
(10) Pub. No.: US 2026/0342379 A1
(43) Pub. Date: Oct. 29, 2026

(54) CHIP FOR COLLISION DETECTION OF RF SIGNALS, TRANSCEIVER INCLUDING THE SAME, AND METHOD OF DETECTING COLLISION OF THE RF SIGNALS

(71) Applicant: Samsung Electronics Co., Ltd., Suwon-si (KR)

(72) Inventor: YOUNG-SEOK KIM, Suwon-si (KR)

(21) Appl. No.: 19/643,271

(22) Filed: Apr. 9, 2026

(30) Foreign Application Priority Data
Apr. 25, 2025 (KR) 10-2025-0054490

(51) Int. Cl. H04B 5/24

(52) U.S. Cl. CPC H04B 5/24

(57) ABSTRACT

A near field communication (NFC) device includes a front-end circuit including an antenna and a matching network circuit coupled to the antenna, a transmission circuit transmitting a first radio frequency (RF) signal through the front-end circuit, a reception circuit receiving a second RF signal, the second RF signal being a signal generated from the transmitting of the first RF signal through the front-end circuit, a feedback circuit providing a feedback path from the reception circuit to the transmission circuit and extracting, from the second RF signal, a clock having the same frequency as the second RF signal, and a controller determining an occurrence and nonoccurrence of an RF collision with respect to the NFC device based on the clock.

### CROSS-REFERENCE TO RELATED APPLICATIONS

This application claims priority under 35 U.S.C. § 119 to Korean Patent Application No. 10-2025-0054490 filed on Apr. 25, 2025, in the Korean Intellectual Property Office, the disclosure of which is incorporated by reference herein in its entirety.

### BACKGROUND

Embodiments of the present disclosure described herein relate to a chip for collision detection of RF signals, a transceiver including the chip, and a method of detecting collision of the RF signals.

Near field communication (NFC) is a contactless communication technology that transmits and receives data using a reference frequency (e.g., 13.56 MHz) at a short distance. NFC technology supports a poll mode, which actively transmits signals, and a listen mode, which receives and responds to signals. The NFC is utilized in various fields, such as payments, authentication, and information sharing.

When NFC devices supporting the NFC technology transmit radio frequency (RF) signals to each other (or radiate RF fields), there is a possibility that the RF signals collide. When the collision of the RF signals occurs, it is difficult to proceed with normal NFC.

### SUMMARY

Embodiments of the present disclosure provide a chip for collision detection of RF signals, a transceiver including the chip, and a method of detecting collision of the RF signals.

According to an embodiment, a near field communication (NFC) device includes a front-end circuit including an antenna and a matching network circuit coupled to the antenna, a transmission circuit configured to transmit a first radio frequency (RF) signal through the front-end circuit, a reception circuit configured to receive a second RF signal, the second RF signal being a signal generated from the transmitting of the first RF signal through the front-end circuit, a feedback circuit configured to provide a feedback path from the reception circuit to the transmission circuit and to extract, from the second RF signal, a clock having the same frequency as the second RF signal, and a controller configured to determine an occurrence and nonoccurrence of an RF collision with respect to the NFC device based on the clock.

According to an embodiment, a method of determining an occurrence and nonoccurrence of an RF collision in an NFC device includes transmitting a first RF signal in a poll mode, extracting a clock from a second RF signal, the second RF signal being a signal generated from the transmitting of the first RF signal through a matching network circuit of the NFC device; and determining the occurrence and nonoccurrence of the RF collision with respect to the NFC device based on the clock.

According to an embodiment, a near field communication (NFC) chip includes a transmission circuit configured to transmit a first radio frequency (RF) signal, a reception circuit configured to receive a second RF signal defined as a feedback signal of the first RF signal, a feedback circuit configured to provide a feedback path from the reception circuit to the transmission circuit and to extract, from the second RF signal, a clock having the same frequency as the second RF signal, and a controller configured to determine an occurrence and nonoccurrence of an RF collision with respect to the NFC chip based on the clock.

According to the above, the chip to detect the collision of the RF signals, the transceiver including the chip, and the method of detecting the RF collision are provided.

### BRIEF DESCRIPTION OF THE FIGURES

The above and other objects and features of the present disclosure will become apparent by describing in detail embodiments thereof with reference to the accompanying drawings.

FIG. 1 is a block diagram illustrating a near field communication (NFC) device according to embodiments of the present disclosure;

FIG. 2 is a circuit diagram illustrating a front-end circuit according to embodiments of the present disclosure;

FIG. 3 is a block diagram illustrating a feedback circuit according to embodiments of the present disclosure;

FIG. 4 is a timing diagram illustrating an RF collision prevention operation;

FIG. 5 is a timing diagram illustrating an RF collision prevention operation according to embodiments of the present disclosure;

FIG. 6 is a flowchart illustrating an RF collision prevention operation of an NFC device according to embodiments of the present disclosure;

FIG. 7 is a flowchart illustrating a method of switching a mode of an NFC device according to embodiments of the present disclosure;

FIG. 8 is a block diagram illustrating a controller according to embodiments of the present disclosure;

FIG. 9 is a block diagram illustrating a chip according to embodiments of the present disclosure;

FIG. 10 is a block diagram illustrating an NFC system according to embodiments of the present disclosure;

FIG. 11 is a timing diagram for an RF collision in the NFC system of FIG. 10 according to embodiments of the present disclosure; and

FIG. 12 is a block diagram illustrating an electronic device according to embodiments of the present disclosure.

### DETAILED DESCRIPTION

Below, embodiments of the present disclosure will be described in detail and clearly to such an extent that one of ordinary skill in the art may easily implement the present disclosure.

In the following descriptions, the term “coupled” with respect to component A and component B may refer to a physical connection, an electrical connection, or both, between component A and component B.

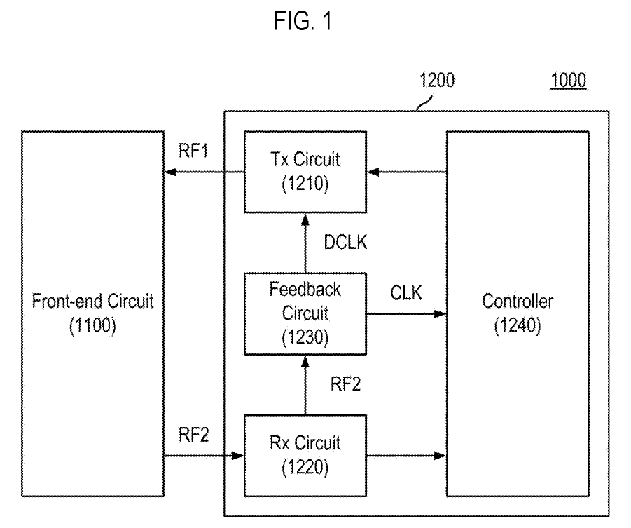

FIG. 1 is a block diagram illustrating a near field communication (NFC) device according to embodiments of the present disclosure.

Referring to FIG. 1, the NFC device 1000 may include a front-end circuit 1100 and a chip 1200.

The front-end circuit 1100 may include an antenna containing an inductance component and a matching network circuit.

In the present disclosure, the “antenna” may include one or more antenna elements, components, or units, or may have a structure and/or arrangement including the antenna elements, components, or units. In some embodiments, the antenna may be configured as a single antenna, and in this case, the transmission of a radio frequency (RF) signal or the reception of the RF signal may be performed through the single antenna.

The matching network circuit (e.g., impedance transformer or a resonant circuit) may be coupled to the antenna. According to some embodiments, the matching network circuit may be configured to provide impedance matching between an output impedance of the chip 1200 and an input impedance of the antenna, or to provide resonance for communication of the NFC device 1000 at a specific frequency through a combination of passive elements. For example, the specific frequency in the NFC device 1000 may be about 13.56 MHz.

The chip 1200 may be coupled to the matching network circuit and configured to process the RF signal. The chip 1200 may operate the NFC device 1000 in a poll mode (an active mode) or a listen mode (a passive mode). For example, the chip 1200 may operate in the poll mode or the listen mode according to a time-division scheme.

The NFC device 1000 operating in the poll mode may be a poller (or an initiator, a reader, an active device, etc.), and the NFC device 1000 operating in the listen mode may be a listener (or a target). Alternatively, an electronic device may be configured to perform both the roles of the poller and the listener.

The poll mode may be defined as a mode in which the RF signal is transmitted. In detail, the poll mode may be defined as a mode in which the NFC device 1000 uses its own (or a unique) RF frequency (or a carrier frequency) for communication. In the poll mode, the NFC device 1000 may generate or obtain the RF signal having the RF frequency and may transmit the RF signal.

The listen mode may be defined as a mode where the NFC device 1000 responds to an external RF signal. In detail, the listen mode may be defined as a mode in which the NFC device 1000 responds to an RF signal transmitted from another NFC device, rather than generating and transmitting the RF signal as in the poll mode. In the listen mode, the NFC device 1000 may receive the RF signal from another NFC device. For example, the NFC device 1000 operating in the listen mode may respond to the RF signal based on a load modulation scheme.

In some embodiments, the chip 1200 may include a transmission (Tx) circuit 1210, a reception (Rx) circuit 1220, a feedback circuit 1230, and a controller 1240.

The Tx circuit 1210 may transmit a first RF signal RF1 through the matching network circuit. In some embodiments, the Tx circuit 1210 may receive a processed and/or modulated baseband signal from the controller 1240, may up-convert the baseband signal to a reference frequency to obtain or oscillate the first RF signal RF1, and may amplify the first RF signal RF1. The Tx circuit 1210 may apply the amplified first RF signal RF1 to the front-end circuit 1100.

The Rx circuit 1220 may receive a second RF signal RF2, which is defined as a signal fed back (e.g., generated) as a result of the transmission of the first RF signal RF1 through the matching network circuit, via the matching network circuit. The Rx circuit 1220 may apply the second RF signal RF2 to the feedback circuit 1230.

Hereinafter, in the present disclosure, the ‘first RF signal RF1’ is defined as an RF signal provided from the Tx circuit 1210 to the front-end circuit 1100 (and the matching network circuit), and the ‘second RF signal RF2’ is defined as an RF signal provided from the front-end circuit 1100 (and the matching network circuit) to the Rx circuit 1220. The second RF signal RF2 may be a signal generated as a result of the transmission of the first RF signal RF1 through the matching network circuit included in the front-end circuit 1100 and fed back to the Rx circuit 1220.

In some embodiments, the Rx circuit 1220 may receive a reception signal from the front-end circuit 1100 when the NFC device 1000 operates in the listen mode and may process the received reception signal (e.g., low-noise amplification, frequency down-conversion, etc.).

The feedback circuit 1230 may provide a feedback path from the Rx circuit 1220 to the Tx circuit 1210 and may extract a clock CLK (i.e., clock CLK signal) from the second RF signal RF2 and transmit the extracted clock CLK to the controller 1240. The extracted clock CLK has the same frequency as the second RF signal RF2. In the present embodiment, the feedback path may be defined as a path through which a signal is fed back to the Tx circuit 1210 via the Rx circuit 1220 and the feedback circuit 1230. The feedback circuit 1230 may provide a closed-loop for the Tx circuit 1210, the matching network circuit, and the Rx circuit 1220 via the feedback path.

The feedback circuit 1230 may apply the clock CLK extracted from the second RF signal RF2 to the controller 1240.

In some embodiments, the feedback circuit 1230 may obtain a delay clock DCLK (i.e., delay clock DCLK signal) based on delaying a phase of the extracted clock CLK by a set phase value. The feedback circuit 1230 may provide the obtained delay clock DCLK to the Tx circuit 1210.

In some embodiments, the Tx circuit 1210 may generate or oscillate the first RF signal RF1 based on the delay clock DCLK provided from the feedback circuit 1230. The first RF signal RF1 may have a frequency that varies according to the set phase value. For example, in a case where the delay clock DCLK is delayed from the clock CLK by a first phase value, the frequency of the first RF signal RF1 may be varied (up or down) by a frequency value corresponding to the first phase value.

As the closed-loop including the above feedback path is formed, a change that may occur in the second RF signal RF2 is directly reflected in the obtaining or oscillation of the first RF signal RF1. For example, when assuming a scenario where the RF collision occurs between the NFC device 1000 and another NFC device (or another poller), the frequency of the signal oscillated through the closed-loop including the antenna may fluctuate when the RF collision occurs. In the case of an open loop, the NFC device 1000 operates based on a fixed oscillation frequency, and thus, the frequency of the oscillated signal does not fluctuate. In contrast, in the case of the closed-loop, the frequency of the oscillated signal may fluctuate due to the RF collision, and a level of the oscillated signal may vary depending on a difference between the oscillation frequency and a resonant frequency of the matching network circuit.

In some embodiments, since the NFC device 1000 oscillates the first RF signal RF1 based on the clock CLK extracted through the closed-loop, the frequencies of the first RF signal RF1 and the second RF signal RF2 corresponding to the first RF signal RF1 may fluctuate due to the RF collision. Accordingly, the frequency of the clock CLK extracted through the feedback circuit 1230 may also fluctuate in response to the frequency fluctuation of the second RF signal RF2.

The controller 1240 may detect whether the RF collision occurs by detecting the frequency fluctuations of the first RF signal RF1 and the second RF signal RF2. The controller 1240 may detect the RF collision with respect to the NFC device 1000 based on the clock CLK.

In some embodiments, the controller 1240 may receive the clock CLK from the feedback circuit 1230 and may obtain the frequency of the clock CLK. The controller 1240 may determine that the RF collision is detected when the obtained frequency of the clock CLK falls outside a set range with respect to the reference frequency. The set range may be variously set to include the reference frequency. The reference frequency may be the same as the specific frequency described above or may be a frequency defined with respect to the delay clock DCLK according to some embodiments.

Based on the detection of the RF collision, the controller 1240 may switch the operation mode of the NFC device 1000 from the poll mode to the listen mode. Accordingly, the NFC device 1000 may avoid the RF collision with another NFC device and may operate in the listen mode. Alternatively, based on the non-detection of the RF collision, the controller 1240 may maintain the operation mode of the NFC device 1000 in the poll mode.

The NFC device 1000 according to the above-described embodiments may have the structure that obtains or oscillates the first RF signal RF1 through the closed-loop and thus may detect the RF collision. Further, when the RF collision is detected, the NFC device 1000 may switch its operation mode to the listen mode, and thus, the NFC device 1000 may actively respond to the RF collision and may improve compatibility with another NFC device.

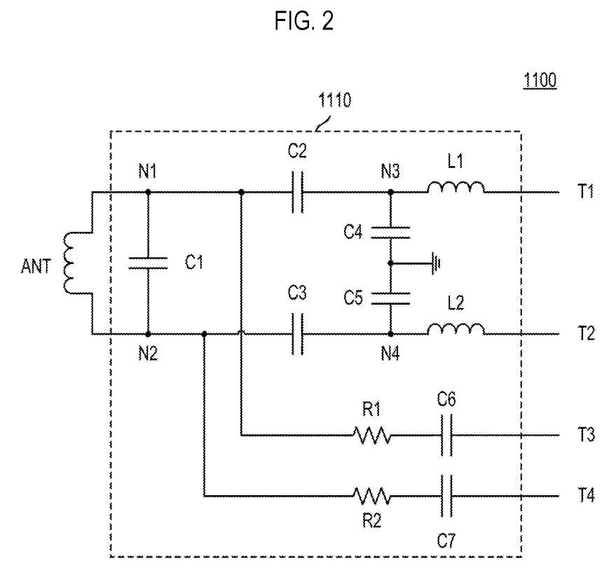

FIG. 2 is a circuit diagram illustrating the front-end circuit 1100 according to embodiments of the present disclosure.

Referring to FIG. 2, the front-end circuit 1100 may include the antenna ANT and the matching network circuit 1110. The antenna ANT may be implemented as a coil. Both ends of the antenna ANT may be coupled to a first node N1 and a second node N2, respectively.

The matching network circuit 1110 may include first, second, third, fourth, fifth, sixth, and seventh capacitors C1, C2, C3, C4, C5, C6, and C7, a first inductor L1, a second inductor L2, a first resistor R1, and a second resistor R2.

The first capacitor C1 may be coupled to the first node N1 and the second node N2. The second capacitor C2 may be coupled to the first node N1 and a third node N3, and the third capacitor C3 may be coupled to the second node N2 and a fourth node N4. One end of the fourth capacitor C4 may be coupled to the third node N3, and the other end of the fourth capacitor C4 may be grounded. One end of the fifth capacitor C5 may be coupled to the fourth node N4, and the other end of the fifth capacitor C5 may be grounded.

The first inductor L1 may be coupled to the third node N3 and a first terminal T1, and the second inductor L2 may be coupled to the fourth node N4 and a second terminal T2. The first terminal T1 and the second terminal T2 may be coupled to the Tx circuit 1210 (refer to FIG. 1) according to the above-described embodiment.

The first resistor may be coupled to the first node N1 and one end of the sixth capacitor C6, and the second resistor may be coupled to the second node N2 and one end of the seventh capacitor C7. The one end of the sixth capacitor C6 may be coupled to the first resistor, and the other end of the sixth capacitor C6 may be coupled to a third terminal T3. The one end of the seventh capacitor C7 may be coupled to the second resistor, and the other end of the seventh capacitor C7 may be coupled to a fourth terminal T4. The third terminal T3 and the fourth terminal T4 may be coupled to the Rx circuit 1220 (refer to FIG. 1) according to the above-described embodiment.

The first resistor, the sixth capacitor C6, the second resistor, and the seventh capacitor C7 may provide attenuation for the RF signal received from the antenna ANT. According to some embodiments, the first resistor and the second resistor may be omitted.

The antenna ANT and the matching network circuit 1110 illustrated in the front-end circuit 1100 of FIG. 2 described above are merely an example, and embodiments of the present disclosure should not be limited thereto or thereby. The antenna ANT and the matching network circuit 1110 may be configured or implemented in various ways to provide resonance and impedance matching for the specific frequency to the NFC device 1000.

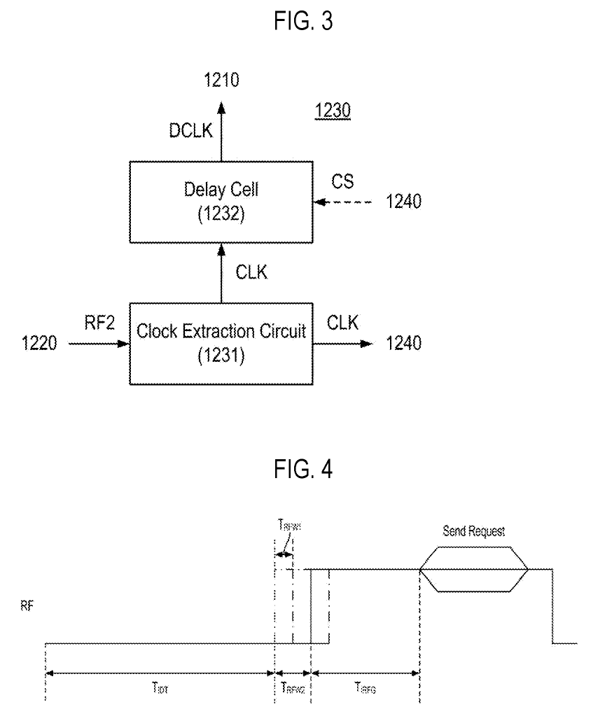

FIG. 3 is a block diagram illustrating the feedback circuit according to embodiments of the present disclosure.

Referring to FIG. 3, the feedback circuit 1230 may include a clock (i.e., clock signal) extraction circuit 1231 and a delay cell 1232.

The clock extraction circuit 1231 may receive the second RF signal RF2 from the matching network circuit. The clock extraction circuit 1231 may extract the clock CLK, which is a digital signal having the same frequency as the frequency of the second RF signal RF2, from the second RF signal RF2. For example, the clock extraction circuit 1231 may extract the clock CLK having logic high and logic low levels from the second RF signal RF2 based on a preset voltage threshold. The clock extraction circuit 1231 may provide the extracted clock CLK to the controller 1240 and the delay cell 1232.

The delay cell 1232 may delay a phase of the provided clock CLK by the set phase value and may obtain the delay clock DCLK. According to various embodiments, the delay cell 1232 may be implemented as a delay chain where one or more inverters or buffers are connected in series, or may be implemented in various other forms capable of delaying the phase of the clock CLK.

The delay cell 1232 may provide the delay clock DCLK to the Tx circuit 1210. The frequency of the first RF signal RF1 (refer to FIG. 1) that is obtained or oscillated by the Tx circuit 1210 may vary depending on the level of the phase value by which the clock CLK is delayed.

In some embodiments, the controller 1240 may control the set phase value. The controller 1240 may provide a control signal CS for setting the phase value to the delay cell 1232. In this case, the delay cell 1232 may delay the phase of the clock CLK by the phase value controlled according to the control signal CS.

According to the embodiments described above, the frequency of the RF signal obtained or oscillated by the Tx circuit 1210 of the NFC device 1000 may vary from the specific frequency according to the delay clock DCLK. Therefore, the NFC device 1000 may transmit the RF signal having a frequency different from the specific frequency transmitted by another NFC device. When the frequencies of the RF signals transmitted by multiple NFC devices 1000 are the same as each other (e.g., the specific frequency), the RF collision may not be detected. The NFC device 1000 according to the present disclosure may transmit the RF signal having the frequency different from the specific frequency, and thus, the NFC device 1000 may further improve performance in detection of the RF collision.

FIG. 4 is a timing diagram illustrating an RF collision prevention operation.

Referring to FIG. 4, the NFC device may support RF collision avoidance (RFCA) to prevent the RF collision, and the controller may control the Tx circuit in response to the RFCA.

First, the NFC device may wait without transmitting the RF signal during a section T_{IDT}. Here, the section T_{IDT} may be defined as an initial delay time during which the NFC device waits to check for the presence of the external RF signal. The NFC device may detect the presence of the external RF signal during the section T_{IDT}.

When the external RF signal is not detected during the section T_{IDT}, the NFC device has an additional waiting time by a section T_{RFW2}. In the present embodiment, the section T_{RFW2} may be defined as the additional time during which the NFC device waits before obtaining or transmitting the RF signal and may be defined based on a section T_{RFW1} that is a unit waiting time. For example, the section T_{RFW2} may be defined by the expression “n×T_{RFW1}”. In this expression, n is a randomly generated integer. Accordingly, NFC devices may probabilistically avoid the RF collision with each other.

When the NFC device does not detect the external RF signal during the sections T_{IDT} and T_{RFW2}, the NFC device may turn on the RF field. That is, the NFC device may operate in the poll mode when no external RF signal is detected. The NFC device may turn on the RF field and may radiate the RF field having the specific frequency through the antenna.

The NFC device may turn on the RF field during a section T_{IRFG}. The section T_{IRFG} may be an initial RF generation time and may be defined as a minimum time that is required to be waited after the RF field is activated and before data is transmitted.

The NFC device may send a request after the section T_{IRFG}. The request may include a frame for communication with nearby NFC devices.

In the case of FIG. 4, when sections T_{RFW2} of the NFC devices are set to be identical, it is difficult to avoid the RF collision.

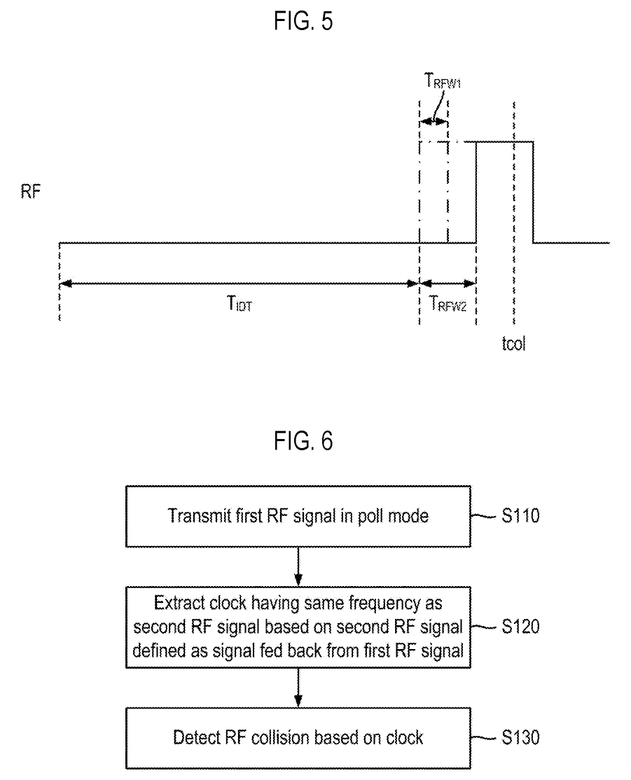

FIG. 5 is a timing diagram illustrating an RF collision prevention operation according to embodiments. Hereinafter, for convenience of explanation, the same detailed descriptions as those in FIG. 4 will be omitted.

Referring to FIG. 5, after the RF field is turned on because the NFC device does not detect the external RF signal during the sections T_{IDT} and T_{RFW2}, the RF collision may occur at a time point tcol. As an example, when the section T_{RFW2} of the NFC device is set to be the same as that of another NFC device, the RF collision may occur because both NFC devices turn on their RF fields.

After turning on the RF field, the NFC device may extract the clock (i.e., clock signal) from the RF field according to the above-described embodiments and may detect the RF collision based on the extracted clock. For example, the NFC device may determine that the RF collision is detected when the frequency of the clock falls outside the set range with respect to the reference frequency.

When the RF collision is detected, the NFC device may turn off the RF field and may operate in the listen mode.

Even though the section T_{RFW2} is set to be the same in the RFCA, the NFC device according to the above-described embodiments may detect the RF collision and may switch the operation mode to the listen mode, and thus, compatibility with other NFC devices may be improved.

FIG. 6 is a flowchart illustrating the RF collision prevention operation of the NFC device according to embodiments of the present disclosure.

Referring to FIG. 6, the NFC device transmits the first RF signal in the poll mode (S110). The NFC device performs the RFCA (refer to FIGS. 4 and 5) according to the embodiments described above for operation in the poll mode.

In operation S120, the NFC device extracts the clock from the second RF signal. The extracted clock having the same frequency as the second RF signal. As detailed above, the second RF signal is defined as the signal generated from the transmission of the first RF signal through the matching network circuit included in the NFC device, and fed back to the Rx circuit included in the NFC device.

In operation S130, the NFC device detects the RF collision with respect to the NFC device based on the clock extracted in operation S120. For example, in operation S130, the NFC device monitors the frequency of the clock extracted and determines that the RF collision is detected when the frequency of the clock fluctuates. For example, the NFC device determines that the RF collision is detected when the frequency of the clock extracted in operation S130 falls outside the set range with respect to the reference frequency.

In some embodiments, the method may further include obtaining the delay clock based on delaying the phase of the clock by the set phase value and obtaining the first RF signal based on the delay clock. In this case, the NFC device may oscillate the first RF signal based on the delay clock.

The NFC device may detect the RF collision through the operation method according to the above-described embodiments.

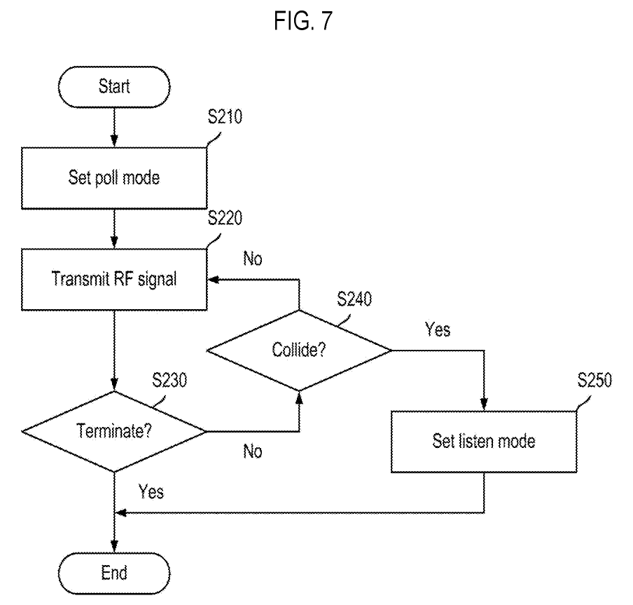

FIG. 7 is a flowchart illustrating a method of switching the mode of the NFC device according to embodiments of the present disclosure.

Referring to FIG. 7, the NFC device sets the poll mode (S210), and the NFC device transmits the RF signal (S220). In operation S230, the NFC device determines whether to terminate the poll mode or not.

When it is determined that the poll mode is to be maintained (indicated as No in operation S230), the NFC device determines whether RF collision has occurred (e.g., RF collision is detected) or whether RF collision has not occurred (e.g., RF collision is not detected) (S240). When the RF collision has occurred (e.g., RF collision is detected) (indicated as Yes in S240), the NFC device sets the listen mode and terminates the poll mode (S250). For example, the NFC device switches its operation mode to the listen mode based on the detection of the RF collision.

The NFC device operating in the listen mode stops generating, obtaining, and transmitting the RF signal and instead receives or responds to the RF signal from an external NFC device.

Alternatively, when the RF collision has not occurred (e.g., RF collision is not detected) (indicated as No in S240), the NFC device returns to operation S220 and transmits the RF signal. For example, the NFC device maintains its operation mode in the poll mode based on the non-detection of the RF collision.

The NFC device may detect the RF collision and actively respond to the RF collision through the operation method according to the above-described embodiment.

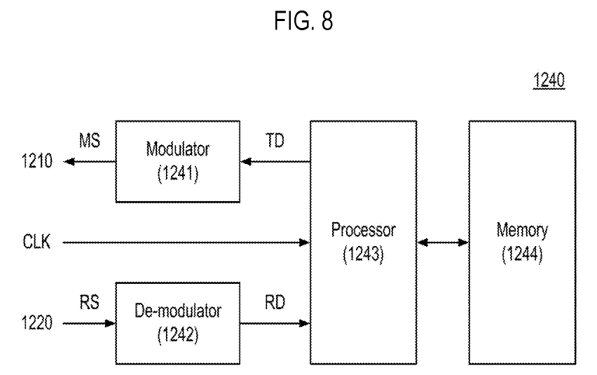

FIG. 8 is a block diagram illustrating the controller according to embodiments of the present disclosure.

Referring to FIG. 8, the controller 1240 may include a modulator 1241, a demodulator 1242, a processor 1243, and a memory 1244.

The modulator 1241 may receive transmission data TD from the processor 1243 and may modulate the transmission data TD. As an example, the modulator 1241 may modulate the transmission data TD based on a modulation scheme, such as amplitude shift keying (ASK), on-off keying (OOK), binary phase shift keying (BPSK), etc. The modulated signal MS is provided to the Tx circuit 1210.

The demodulator 1242 may receive the reception signal RS from the Rx circuit 1220 and may demodulate the reception signal RS to obtain reception data RD. The demodulator 1242 may demodulate the reception signal RS according to a demodulation scheme corresponding to the modulation scheme used by the modulator 1241.

The processor 1243 may be coupled to the memory 1244 and may control an overall operation of the chip and the NFC device.

The processor 1243 may control the memory 1244 and may execute at least one instruction stored in the memory 1244 to implement descriptions, functions, procedures, proposals, methods, and/or operational flowcharts of the present disclosure. Further, the processor 1243 may provide operations according to various embodiments of the present disclosure based on instructions stored in the memory 1244. In addition, the processor 1243 may process information stored in the memory 1244 to generate data.

The processor 1243 may select the operation mode for the NFC device, such as the poll mode and the listen mode, and may control the Tx circuit 1210, the Rx circuit 1220, the modulator 1241, and/or the demodulator 1242 according to the selected mode.

For example, the processor 1243 may turn the RF field on or off according to the selected mode. The processor 1243 may perform the RFCA according to the above-described embodiments to turn on the RF field. For instance, the processor 1243 may generate or obtain the transmission data TD and may provide the transmission data TD to the modulator 1241. For example, the processor 1243 may receive the reception data RD from the demodulator 1242 and may extract valid data from the reception data RD or may check cyclic redundancy check (CRC).

The processor 1243 may store the obtained or processed data in the memory 1244 or may read out data stored in the memory 1244.

In some embodiments, the processor 1243 may receive the clock CLK from the feedback circuit according to the above-described embodiments and may detect the RF collision based on the clock CLK. For example, the processor 1243 may obtain the frequency of the provided clock CLK and may determine that the RF collision is detected when the frequency of the clock CLK fluctuates. Whether the frequency of the clock CLK is fluctuated may be determined through a comparison operation between the frequency of the clock CLK and the reference frequency or a comparison operation between the frequency of the clock CLK and the set range with respect to the reference frequency.

In some embodiments, when the NFC device operates in the poll mode, the processor 1243 may detect the RF collision based on the clock CLK, and when the RF collision is detected, the processor 1243 may switch the operation mode of the NFC device from the poll mode to the listen mode. Alternatively, when no RF collision is detected, the processor 1243 may maintain the operation mode of the NFC device in the poll mode.

The memory 1244 may be connected to the processor 1243 and may store various information related to the operation of the processor 1243. For example, the memory 1244 may store software code including at least one instruction for performing some or all of processes controlled by the processor 1243, or for implementing the descriptions, functions, procedures, proposals, methods, and/or operational flowcharts of the present disclosure.

The controller 1240 according to the above-described embodiments may detect the RF collision based on the clock CLK and may improve compatibility with other NFC devices through the mode switch upon detecting the RF collision.

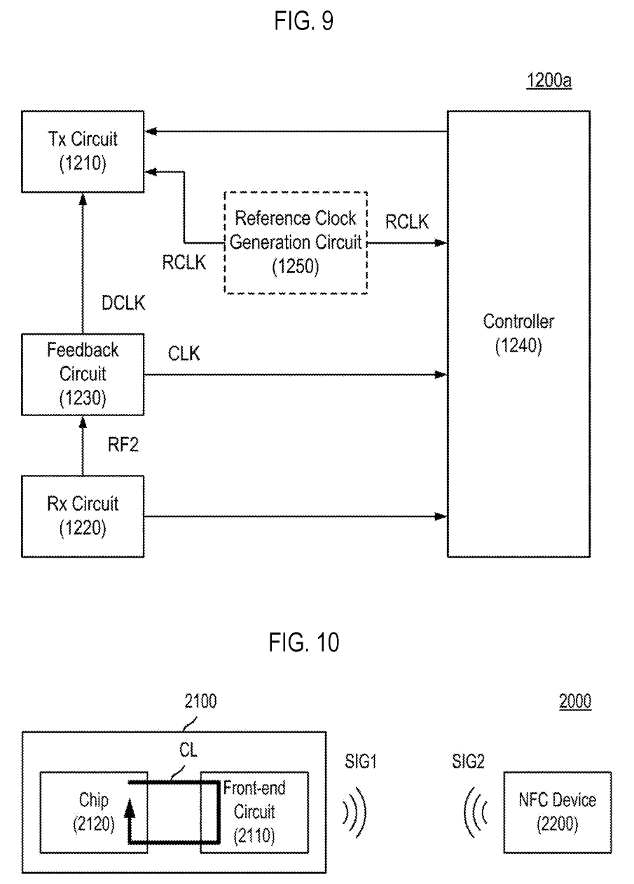

FIG. 9 is a block diagram illustrating a chip according to embodiments of the present disclosure. Hereinafter, for convenience of explanation, the same detailed descriptions as those in FIG. 1 will be omitted.

Referring to FIG. 9, the chip 1200a may further include a reference clock generation circuit 1250 in addition to a Tx circuit 1210, an Rx circuit 1220, a feedback circuit 1230, and a controller 1240.

According to various embodiments, the reference clock generation circuit 1250 may generate a reference clock RCLK that may be used to generate a specific frequency required by an NFC device. For example, the reference clock generation circuit 1250 may be implemented as a crystal oscillator, an RC oscillator, a frequency divider, or the like. The reference clock generation circuit 1250 may provide the reference clock RCLK to the Tx circuit 1210 and the controller 1240.

In some embodiments, the Tx circuit 1210 may receive the reference clock RCLK from the reference clock generation circuit 1250 and may oscillate an initial RF signal based on the reference clock RCLK. After oscillating the initial RF signal, the Tx circuit 1210 may oscillate the RF signal based on a delay clock DCLK. In this case, the reference clock RCLK may be a clock matched to a specific frequency. For example, the Tx circuit 1210 may initially oscillate the RF signal at the specific frequency, and then, may oscillate the RF signal at the frequency matched to the delay clock DCLK.

In some embodiments, the controller 1240 may use the provided reference clock RCLK for the detection of the RF collision. The controller 1240 may compare the reference clock RCLK, which is matched to the specific frequency, with the clock CLK, and may determine that the RF collision is detected when the clock CLK falls outside the set range of the reference clock RCLK.

The operations of the reference clock generation circuit 1250 according to the embodiments are merely an example, and the present disclosure should not be limited thereto or thereby. For example, as illustrated in FIG. 1, the NFC device may be configured to initially oscillate at the specific frequency without the separate reference clock RCLK, or the NFC device may operate in response to the reference clock RCLK applied from an external source.

FIG. 10 is a block diagram illustrating an NFC system according to embodiments of the present disclosure.

Referring to FIG. 10, the NFC system 2000 according to some embodiments may include a first NFC device 2100 and a second NFC device 2200. The first NFC device 2100 and the second NFC device 2200 may perform near-field communication with each other based on an NFC scheme. For example, the first NFC device 2100 may operate in both a poll mode and a listen mode, and the second NFC device 2200 may operate in both the poll mode and the listen mode or may operate only in the poll mode. The second NFC device 2200 operable only in the poll mode may be a poller (or an initiator, a reader, or an active device).

When both the first NFC device 2100 and the second NFC device 2200 operate in the poll mode, the first NFC device 2100 may turn on its RF field and may emit a first signal SIG1, and the second NFC device 2200 may turn on its RF field and may emit a second signal SIG2. For example, the first NFC device 2100 may obtain or generate and emit the first signal SIG1 having a reference frequency that is identical to a specific frequency or is defined with respect to a delay clock. For example, the second signal SIG2 may have the specific frequency. When the first signal SIG1 has the frequency defined with respect to the delay clock, the performance of the RF collision detection may be further improved.

In some embodiments, the first NFC device 2100 may include a front-end circuit 2110 and a chip 2120 and may perform an RF collision detection operation (refer to FIGS. 1-9). The first NFC device 2100 may include a closed-loop CL to detect the RF collision. Through the closed-loop CL, the first signal SIG1 may be oscillated according to a clock of an internally fed back first signal SIG1 (e.g., the second RF signal described above).

In some embodiments, the RF collision may occur as the first NFC device 2100 and the second NFC device 2200 transmit signals to each other. When the RF collision occurs, a variation may occur in the first signal SIG1, and the variation in the first signal SIG1 may also be reflected in the signal fed back through the closed-loop CL. The first NFC device 2100 may detect the RF collision from a frequency variation of the first signal SIG1, and when the RF collision is detected, the operation mode of the first NFC device 2100 may be switched to the listen mode.

In some embodiments, the second NFC device 2200 may only support the poll mode. The first NFC device 2100 may first transmit the first signal SIG1 in the poll mode. Since the second NFC device 2200 does not recognize the first signal SIG1 transmitted by the first NFC device 2100, the second NFC device 2200 may also transmit the second signal in the poll mode. In this case, the RF collision may occur, and the variation may occur in the first signal SIG1. As described above, the first NFC device 2100 may avoid the RF collision by detecting the RF collision from the frequency variation of the first signal SIG1 and subsequently switching its operation mode to the listen mode when the RF collision is detected.

Therefore, the NFC system 2000 may detect and subsequently avoid (e.g., remove) the RF collision between NFC devices.

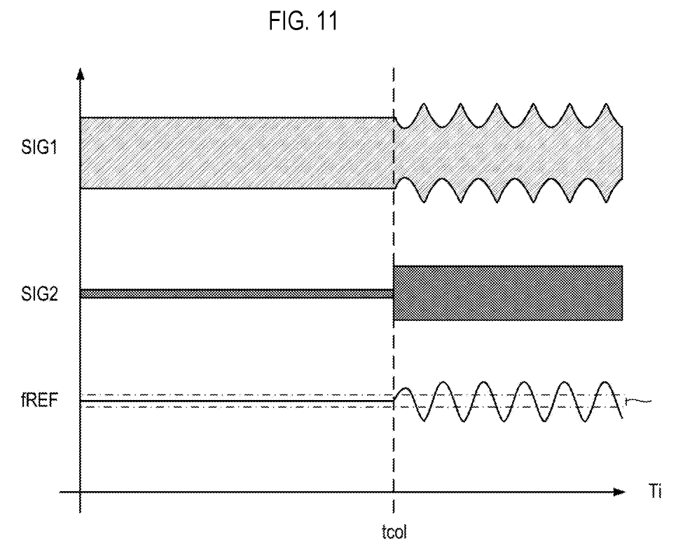

FIG. 11 is a timing diagram for the RF collision in the NFC system of FIG. 10 according to embodiments of the present disclosure.

Referring to FIG. 11, each of the first signal SIG1 and the second signal SIG2 may be emitted with a constant level until an RF collision time point tcol. A reference frequency fREF, which is the frequency of the first signal SIG1, may also maintain a constant value until the RF collision time point tcol.

After the RF collision time point tcol, an intensity of both the first signal SIG1 and the second signal SIG2 fluctuates as the first signal SIG1 and the second signal SIG2 overlap. In this case, the reference frequency fREF may also fluctuate after the RF collision time point tcol. For example, when the RF collision occurs, the reference frequency fREF of the first NFC device 2100 having the closed loop may fluctuate after the RF collision time point tcol, and the first NFC device 2100 may detect the RF collision through the fluctuation. For example, the first NFC device 2100 may determine that the RF collision is detected when the reference frequency fREF fluctuates beyond a set range SR with respect to the reference frequency fREF.

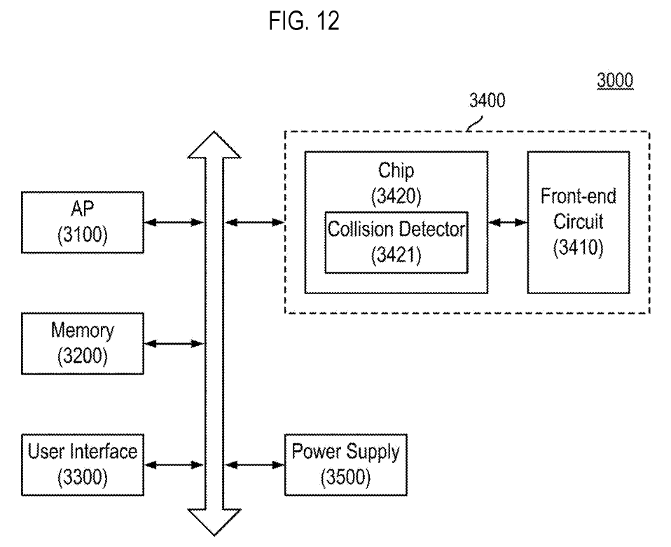

FIG. 12 is a block diagram illustrating an electronic device according to embodiments of the present disclosure.

Referring to FIG. 12, the electronic device 3000 may include an application processor (AP) 3100, an NFC device 3400, a memory 3200, a user interface 3300, and a power supply 3500.

For example, the electronic device 3000 may be any mobile system, such as a mobile phone, a smartphone, a personal digital assistant (PDA), a portable multimedia player (PMP), a digital camera, a music player, a portable game console, a navigation system, a laptop computer, or the like.

The AP 3100 may control the overall operation of the electronic device 3000. For example, the AP 3100 may execute applications that provide an internet browser, games, videos, and the like. The AP 3100 may include a single core or multiple processor cores (multi-core).

The memory 3200 may store data necessary for the operation of the electronic device 3000. For example, the memory 3200 may store a boot image or firmware to boot the electronic device 3000 and may store output data to be transmitted to an external device (e.g., an NFC enabled external device) and received input data that is received, for example, from the external device.

The user interface 3300 may include one or more input devices, such as a keypad or a touch screen, and/or one or more output devices, such as a speaker or a display device.

The NFC device 3400 may transmit the output data stored in the memory 3200 to the external device via NFC, may receive the input data from the external device via NFC, and may store the input data in the memory 3200. The NFC device 3400 may include a front-end circuit 3410 and a chip 3420.

In some embodiments, the chip 3420 may include a collision detector 3421. The collision detector 3421 may perform the RF collision detection operation according to the above-described embodiments (refer to FIGS. 6 and 7). In some embodiments, the collision detector 3421 may extract a clock having the same frequency as a second RF signal, which is defined as a feedback signal of a first RF signal, and may detect the RF collision with respect to the NFC device 3400 based on the extracted clock.

The power supply 3500 may supply power necessary for the operation of the electronic device 3000.

The electronic device 3000 according to the embodiments may detect and subsequently avoid the RF collision with another device through the NFC device 3400, which is capable of detecting the RF collision.

Although the embodiments of the present disclosure have been described, it is understood that the present disclosure should not be limited to these embodiments but various changes and modifications can be made by one ordinary skilled in the art within the spirit and scope of the present disclosure as hereinafter claimed. Therefore, the disclosed subject matter should not be limited to any single embodiment described herein, and the scope of the present inventive concept shall be determined according to the attached claims.

What is claimed is:

1. A near field communication (NFC) device comprising:
a front-end circuit comprising an antenna and a matching network circuit coupled to the antenna;
a transmission circuit configured to transmit a first radio frequency (RF) signal through the front-end circuit;
a reception circuit configured to receive a second RF signal, the second RF signal being a signal generated from the transmitting of the first RF signal through the front-end circuit;
a feedback circuit configured to provide a feedback path from the reception circuit to the transmission circuit and to extract, from the second RF signal, a clock having a same frequency as the second RF signal; and
a controller configured to determine an occurrence and nonoccurrence of an RF collision with respect to the NFC device based on the clock.

2. The NFC device of claim 1, wherein the controller is configured to switch an operation mode of the NFC device from a poll mode to a listen mode in response to determining the occurrence of the RF collision.

3. The NFC device of claim 2, wherein the poll mode is defined as a mode in which the first RF signal is transmitted, and the listen mode is defined as a mode in which the NFC device responds to an external RF signal.

4. The NFC device of claim 3, wherein the controller is configured to maintain the operation mode of the NFC device in the poll mode in response to determining the nonoccurrence of the RF collision.

5. The NFC device of claim 1, wherein the feedback circuit is configured to provide a closed-loop with respect to the transmission circuit, the matching network circuit, and the reception circuit through the feedback path.

6. The NFC device of claim 1, wherein the feedback circuit is configured to obtain a delay clock based on delaying a phase of the clock by a set phase value and to provide the delay clock to the transmission circuit.

7. The NFC device of claim 6, wherein the transmission circuit is configured to oscillate the first RF signal based on the delay clock.

8. The NFC device of claim 7, wherein the first RF signal has a frequency that varies according to the set phase value.

9. The NFC device of claim 6, wherein the controller is configured to control the set phase value.

10. The NFC device of claim 1, wherein the controller is configured to determine the occurrence of the RF collision when the frequency of the clock falls outside a set range with respect to a reference frequency.

11. A method of determining an occurrence and nonoccurrence of an RF collision in an NFC device, comprising:
transmitting a first RF signal in a poll mode;
extracting a clock from a second RF signal, the second RF signal being a signal generated from the transmitting of the first RF signal through a matching network circuit of the NFC device; and
determining the occurrence and nonoccurrence of the RF collision with respect to the NFC device based on the clock.

12. The method of claim 11, further comprising switching an operation mode of the NFC device from the poll mode to a listen mode in response to determining the occurrence of the RF collision.

13. The method of claim 11, further comprising maintaining an operation mode of the NFC device in the poll mode in response to determining the nonoccurrence of the RF collision.

14. The method of claim 11, further comprising:
obtaining a delay clock based on delaying a phase of the clock by a set phase value; and
oscillating the first RF signal based on the delay clock.

15. The method of claim 14, wherein the first RF signal has a frequency that varies according to the set phase value.

16. The method of claim 11, wherein the occurrence of the RF collision is determined when the frequency of the clock falls outside a set range with respect to a reference frequency.

17. A near field communication (NFC) chip comprising:
a transmission circuit configured to transmit a first radio frequency (RF) signal;
a reception circuit configured to receive a second RF signal defined as a feedback signal of the first RF signal;
a feedback circuit configured to provide a feedback path from the reception circuit to the transmission circuit and to extract, from the second RF signal, a clock having a same frequency as the second RF signal; and
a controller configured to determine an occurrence and nonoccurrence of an RF collision with respect to the NFC chip based on the clock.

18. The chip of claim 17, wherein the controller is configured to switch an operation mode of the NFC chip from a poll mode to a listen mode in response to determining the occurrence of the RF collision.

19. The chip of claim 18, wherein the controller is configured to maintain the operation mode of the NFC chip in the poll mode in response to determining the nonoccurrence of the RF collision.

20. The chip of claim 17, wherein the controller is configured to determine the occurrence of the RF collision when the frequency of the clock falls outside a set range with respect to a reference frequency.
